(19) United States
(12) Patent Application Publication
(10) Pub. No.: US 2009/0230089 A1
(43) Pub. Date: Sep. 17, 2009

(54) ELECTRICAL CONTROL OF PLASMA UNIFORMITY USING EXTERNAL CIRCUIT

(76) Inventors: KALLOL BERA, San Jose, CA (US); SHAHID RAUF, Pleasanton, CA (US); AJIT BALAKRISHNA, Sunnyvale, CA (US); KENNETH S. COLLINS, San Jose, CA (US); KARTIK RAMASWAMY, San Jose, CA (US); HIROJI HANAWA, Sunnyvale, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/047,492

(22) Filed: Mar. 13, 2008

(51) Int. Cl. B01J 19/08; C23F 1/00

(52) U.S. Cl. 216/67; 156/345.34; 204/164

(57) ABSTRACT

A method and apparatus for controlling plasma uniformity is disclosed. When etching a substrate, a non-uniform plasma may lead to uneven etching of the substrate. Impedance circuits may alleviate the uneven plasma to permit more uniform etching. The impedance circuits may be disposed between the chamber wall and ground, the showerhead and ground, and the cathode can and ground. The impedance circuits may comprise one or more of an inductor and a capacitor. The inductance of the inductor and the capacitance of the capacitor may be predetermined to ensure the plasma is uniform. Additionally, the inductance and capacitance may be adjusted during processing or between processing steps to suit the needs of the particular process.

### BACKGROUND

1. Field

Embodiments of the present invention generally relate to a method and apparatus for controlling plasma uniformity.

2. Description of the Related Art

When processing substrates in a plasma environment, the uniformity of the plasma will affect the uniformity of processing. For example, in a plasma deposition process, if the plasma is greater in the area of the chamber corresponding to the center of the substrates, then more deposition will likely occur in the center of the substrate as compared to the edge of the substrate. Similarly, if the plasma is greater in an area of the chamber corresponding to the edge of the substrate, more deposition will likely occur on the edge of the substrate as compared to the center.

In an etching process, if the plasma is greater in the area of the chamber corresponding to the center of the substrate, more material will likely be removed or etched from the substrate in the center of the substrate as compared to the edge of the substrate. Similarly, if the plasma is greater in the area of the chamber corresponding to the edge of the substrate, more material may be removed or etched from the substrate at the edge of the substrate compared to the center of the substrate.

Non-uniformity in plasma processes can significantly decrease device performance and lead to waste because the deposited layer or etched portion is not consistent across the substrate. If the plasma could be made uniform, a consistent deposition or etch is more likely to occur. Therefore, there is a need in the art for a method and an apparatus for controlling plasma uniformity in a plasma process.

### SUMMARY

Embodiments of the present invention generally comprises a method and an apparatus for controlling the uniformity of a plasma. In one embodiment, a plasma processing apparatus comprises a chamber body, a substrate support disposed within the chamber body, and a showerhead disposed within the chamber body opposite to the substrate support. A power supply is coupled with the substrate support. At least one item selected from the group consisting of a capacitor, an inductor, and combinations thereof is coupled to at least two of the chamber body, the showerhead, and the substrate support.

In another embodiment, a plasma processing apparatus comprises a chamber body, a substrate support disposed within the chamber body, and a showerhead disposed within the chamber body opposite to the substrate support. A power supply is coupled with the showerhead. A cathode can is disposed within the chamber body. At least one item selected from the group consisting of a capacitor, an inductor, and combinations thereof is coupled to at least two of the chamber body, the substrate support, the showerhead, and the cathode can. The cathode can substantially encircles the substrate support.

In another embodiment, an etching apparatus comprises a chamber body, a substrate support disposed within the chamber body, and a showerhead disposed within the chamber body opposite to the substrate support. A power supply is coupled with the substrate support. A first capacitor is coupled with the showerhead, and a first inductor is coupled to the showerhead. A second capacitor is coupled to the chamber body, and a second inductor is coupled to the chamber body.

In another embodiment, a plasma distribution controlling method comprises applying a current to a substrate disposed within a processing chamber on a substrate support. The processing chamber has a chamber body and a showerhead disposed within the chamber body opposite to the substrate. The method further comprises coupling at least two of the showerhead, the chamber body, and the substrate support to an item selected from the group consisting of an inductor, a capacitor, and combinations thereof to adjust the plasma distribution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic cross sectional view of a plasma processing apparatus.

FIG. 2 is a schematic cross sectional view of an etching apparatus according to one embodiment of the invention.

FIG. 3 is a schematic cross sectional view of an etching apparatus according to another embodiment of the invention.

FIG. 4 shows the plasma uniformity distribution according to one embodiment of the invention.

FIGS. 5A and 5B show the plasma uniformity distribution according to another embodiment of the invention.

FIGS. 6A and 6B show the plasma uniformity distribution according to another embodiment of the invention.

FIGS. 7A-7D show the plasma uniformity distribution according to another embodiment of the invention.

FIGS. 8A-8F show the plasma uniformity distribution according to another embodiment of the invention.

FIGS. 9A-9D show the plasma uniformity distribution according to another embodiment of the invention.

FIGS. 10A-10B show the plasma uniformity distribution according to another embodiment of the invention.

FIGS. 11A-11E show additional impedance circuits that may be utilized.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally comprises a method and an apparatus for controlling plasma uniformity. While the embodiments will be described below in regards to an etching apparatus and method, it is to be understood that the embodiments have equal application in other plasma processing chambers and processes. One exemplary apparatus in which the invention may be practiced is the ENABLER™ etching chamber available from Applied Materials, Inc., Santa Clara, Calif. It is to be understood that embodiments of the present invention may be practiced in other chambers, including those sold by other manufacturers.

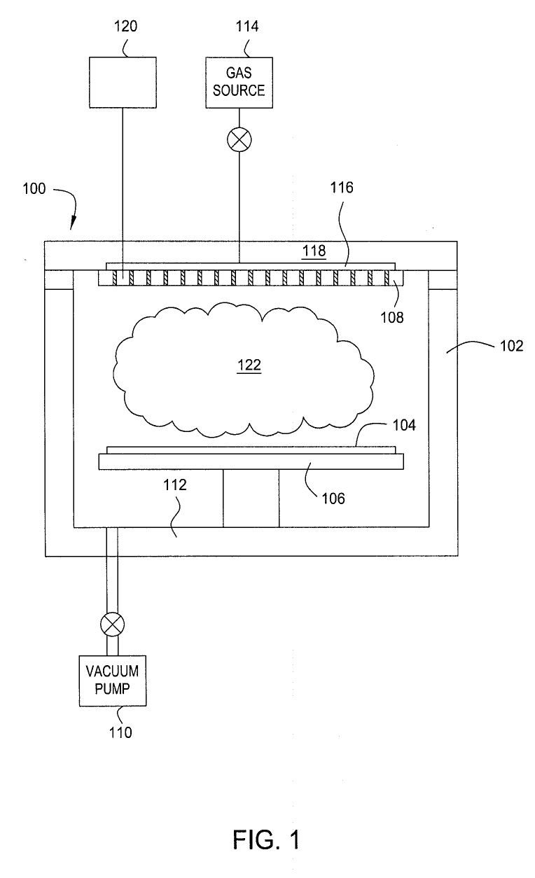

FIG. 1 is a schematic cross sectional view of a plasma processing apparatus 100. The apparatus 100 comprises a chamber 102 having a substrate 104 disposed therein on a susceptor 106. The susceptor 106 may be movable between a lowered position and a raised position. The substrate 104 and susceptor 106 may be disposed within the chamber 102 opposite a showerhead 108. The chamber 102 may be evacuated by a vacuum pump 110 coupled to a bottom 112 of the chamber 102.

Processing gas may be introduced to the chamber 102 from a gas source 114 through the showerhead 108. The gas may be introduced into a plenum 116 disposed between a backing plate 118 and the showerhead 108. The gas may then pass through the showerhead 108 where it is ignited into a plasma 122 by a current applied to the showerhead 108 by a power source 120. In one embodiment, the power source 120 may comprise an RF power source.

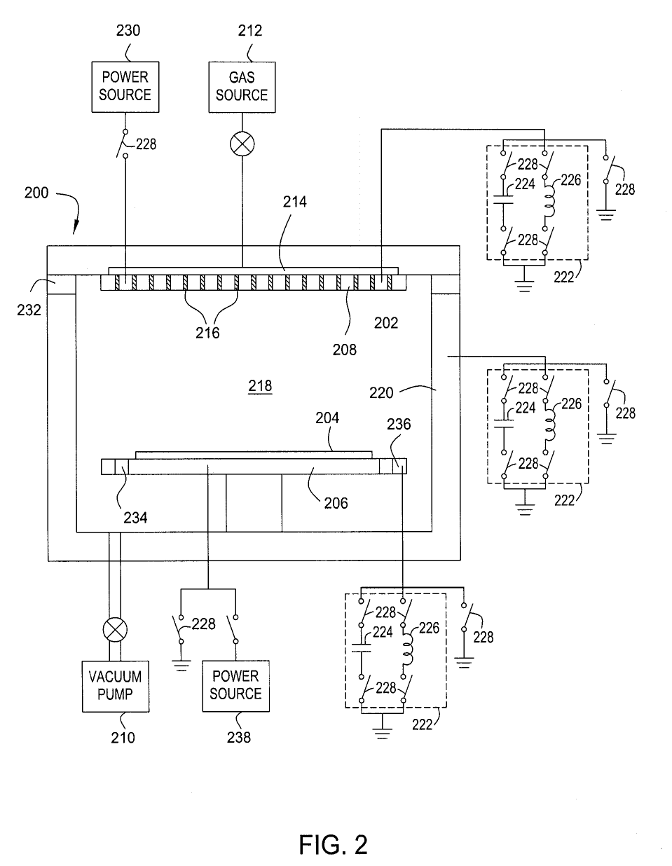

FIG. 2 is a schematic cross sectional view of an etching apparatus 200 according to one embodiment of the invention. The apparatus 200 comprises a processing chamber 202 having a substrate 204 disposed therein. The substrate 204 may be disposed on a susceptor 206 that is movable between a raised and a lowered position. The substrate 204 and the susceptor 206 may sit opposite to a showerhead 208 within the processing chamber 202. A vacuum pump 210 may draw a vacuum within the processing chamber 202. The vacuum pump 210 may be disposed under the susceptor 206.

Processing gas may be provided to the processing chamber 202 from a gas source 212 to a plenum 214 above the showerhead 208. The processing gas may flow through gas passages 216 into the processing area 218. The showerhead 208 may be biased with a current from a power source 230. The current may flow to the showerhead 208 whenever the switch 228 is turned on. In one embodiment, the power source 230 may comprise an RF power source. In another embodiment, the showerhead 208 may be open or at floating potential.

When the substrate 206 is biased, an RF current applied to the substrate 206 will travel to ground out of the showerhead 208 and/or through the chamber wall 220. The easier the path to ground, the more RF current will follow the path. Hence, if both a showerhead 208 and chamber wall 220 are grounded, the plasma may be drawn closer to the chamber wall 220 due to its proximity to the RF current source. The plasma drawn to the chamber wall 220 may result in more etching at the edge of the substrate 206. If the plasma within the chamber 202 were uniform, then the etching within the chamber 202 would be uniform.

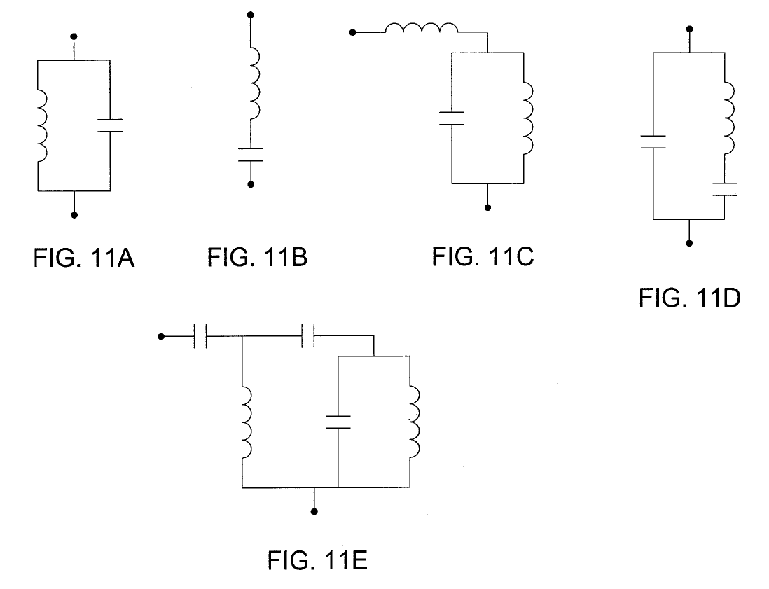

In order to control the plasma within the processing chamber 202, impedance circuits 222 may be coupled to the chamber wall 220 and/or the showerhead 208. When a capacitor 224 is a part of the impedance circuit, the capacitor 224 may push the plasma from the location to which the capacitor 224 is coupled. The capacitor 224 disconnects the item from ground. The capacitor 224 impedes the current from flowing to ground. An inductor 226, on the other hand, functions opposite to that of the capacitor 224. The inductor pulls the plasma closer to the object coupled to the inductor 226. The voltage drop across the inductor is out of phase with the biased object (i.e., the showerhead 208 or the substrate 206) and hence increases relative to ground. Thus, more current flows through the inductor 226 to ground than directly to ground. When both an inductor 226 and a capacitor 224 are present, the capacitance and/or the inductance may be tailored to meet the particular needs of the user. For multiple RF applications, various combinations of series and parallel circuit elements and/or transmission lines may be used to achieve the desired impedance. FIGS. 11A-11E show several impedance circuits that may be utilized. It is to be understood that other impedance circuits may be utilized as well.

The processing chamber 202 may have a chamber wall 220. The chamber wall 220 may be coupled directly to ground or coupled to an impedance circuit 222 that is coupled to ground. The impedance circuit 222 may comprise a capacitor 224 and/or an inductor 226. The capacitor 224 may have switch 228 that couples the capacitor to the chamber wall 220 and a switch 228 that couples the capacitor 224 to ground. Similarly, the inductor 226 has a switch that couples the inductor 226 to the chamber wall 220 and a switch 228 that couples the inductor 226 to ground. In one embodiment, a capacitor 224 may be present without an inductor 226. In another embodiment, an inductor 226 may be present without a capacitor 224. In another embodiment, both a capacitor 224 and an inductor 226 may be present. In another embodiment, the wall 220 may be coupled directly to ground without coupling to a capacitor 224 and/or an inductor 226.

The showerhead 208 may also be coupled to ground through an impedance circuit 222, directly to ground, to a power source 230, or open at a floated potential. The impedance circuit 222 may comprise a capacitor 224 and/or an inductor 226. The capacitor 224 may have switch 228 that couples the capacitor to the showerhead 208 and a switch 228 that couples the capacitor 224 to ground. Similarly, the inductor 226 has a switch 228 that couples the inductor 226 to the showerhead 208 and a switch 228 that couples the inductor 226 to ground. In one embodiment, a capacitor 224 may be present without an inductor 226. In another embodiment, an inductor 226 may be present without a capacitor 224. In another embodiment, both a capacitor 224 and an inductor 226 may be present. In another embodiment, the showerhead 208 may be coupled directly to ground without coupling to a capacitor 224 and/or an inductor 226. In another embodiment, the showerhead 208 may be open at a floating potential. In another embodiment, the showerhead 208 may be coupled to a power source 230. The showerhead 208 may be electrically isolated from the chamber wall 220 by a spacer 232. In one embodiment, the spacer 232 may comprise a dielectric material.

The susceptor 206 may be coupled to ground, coupled to a power source 238, or open at a floating potential. In one embodiment, the power source 238 may comprise an RF power source. Switches 228 may be used to couple the susceptor 206 to the power source 238 or ground.

In one embodiment, a cathode can 236 may at least partially surround the susceptor 206. The cathode can 236 may provide additional control of the plasma uniformity. The cathode can 236 may be electrically isolated from the susceptor 206 by a spacer 234. In one embodiment, the spacer 234 may comprise a dielectric material. The cathode can 236 may be used to control the plasma within the processing chamber 202. The cathode can 236 may be coupled directly to ground or coupled to an impedance circuit 222 that is coupled to ground. The impedance circuit 222 may comprise a capacitor 224 and/or an inductor 226. The capacitor 224 may have switch 228 that couples the capacitor 224 to the cathode can 236 and a switch 228 that couples the capacitor 224 to ground. Similarly, the inductor 226 has a switch 228 that couples the inductor 226 to the cathode can 236 and a switch 228 that couples the inductor 226 to ground. In one embodiment, a capacitor 224 may be present without an inductor 226. In another embodiment, an inductor 226 may be present without a capacitor 224. In another embodiment, both a capacitor 224 and an inductor 226 may be present. In another embodiment, the cathode can 236 may be coupled directly to ground without coupling to a capacitor 224 and/or an inductor 226.

It should be understood that various embodiments discussed above may be utilized in any combination. For example, the cathode can 236 may or may not be present. If the cathode can 236 is present, the impedance circuit 222 may or may not be present. Similarly, an impedance circuit 222 may or may not be coupled to the chamber wall 220. Similarly, an impedance circuit may or may not be coupled to the showerhead 208. If the impedance circuit 222 is present, the capacitor 224 may or may not be present and the inductor 226 may or may not be present. The showerhead 208 may be coupled directly to ground, coupled to an impedance circuit 222, or left open at a floating potential. The susceptor 206 may be coupled directly to ground or left open at a floating potential. Additionally, the wall 220 may be left open at a floating potential.

The apparatus 200 may comprise a movable cathode (not shown) and may comprise a processing region without discontinuities. Without discontinuities may include a slit valve opening disposed at a location below the processing area. Additionally, multiple RF sources may be coupled to the apparatus 200. Various combinations of series and parallel circuit elements and/or transmission lines may be used to achieve the desired impedance. FIGS. 11A-11E show several impedance circuits that may be utilized. It is to be understood that other impedance circuits may be utilized as well.

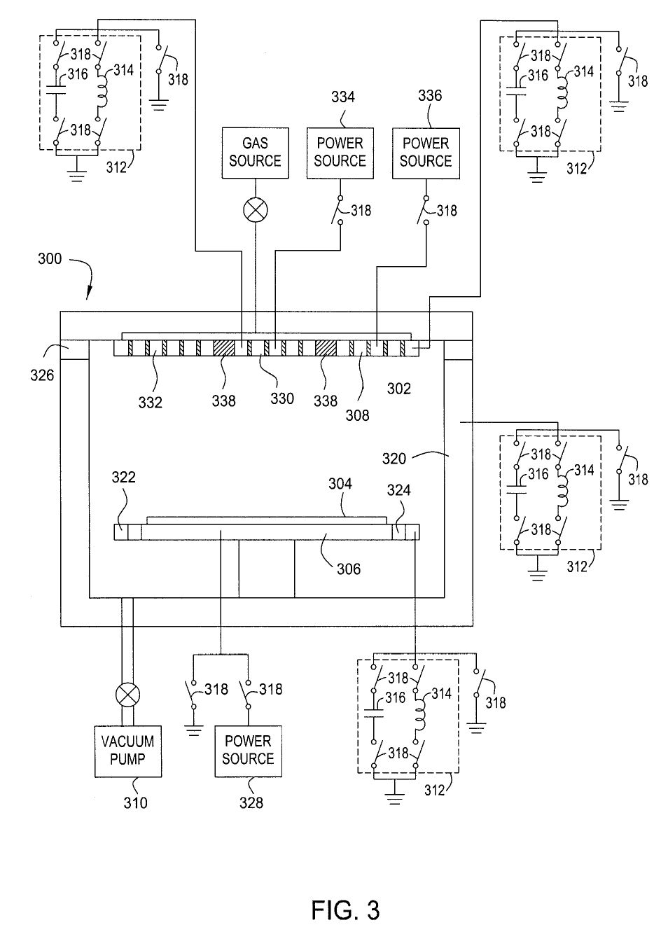

FIG. 3 is a schematic cross sectional view of an etching apparatus 300 according to another embodiment of the invention. The apparatus 300 comprises a processing chamber 302 having a substrate 304 disposed therein. The substrate 304 may be disposed on a susceptor 306 opposite to a showerhead 308. The susceptor 306 may be movable between a raised position and a lowered position. A vacuum pump 310 may evacuate the processing chamber 302 to the desired pressure.

Similar to the embodiment shown in FIG. 2, an impedance circuit 312 may be used to control the plasma uniformity. The impedance circuit 312 may have an inductor 314 and/or a capacitor 316. The impedance circuit 312 may have one or more switches 318 that may couple the capacitor 316 and/or the inductor 314 to ground and/or to the object. Impedance circuits 312 may be coupled to the chamber wall 320, to the showerhead 308, and to a cathode can 322, if present. The cathode can 322, if present, may be spaced form the susceptor 306 by a spacer 324. In one embodiment, the spacer 324 may comprise a dielectric material. Similarly, the showerhead 308 may be electrically isolated from the chamber wall 320 by a spacer 326. In one embodiment, the spacer 326 may comprise a dielectric material.

The susceptor 306 may be coupled directly to ground, coupled to a power source 328, or left open at a floating potential. The showerhead 308 may have two or more separate zones. The showerhead 308 may comprise a first zone 330 and a second zone 332. In one embodiment, the second zone 332 may encircle the first zone 330. Both the first zone 330 and the second zone 332 may each be coupled directly to ground, coupled to an impedance circuit 312, or coupled to a power source 334, 336. The first zone 330 may be electrically isolated from the second zone 332 by a spacer 338. In one embodiment, the spacer 338 may comprise a dielectric material.

It should be understood that various embodiments discussed above may be utilized in any combination. For example, the cathode can 322 may or may not be present. If the cathode can 322 is present, the impedance circuit 312 may or may not be present. Similarly, an impedance circuit 312 may or may not be coupled to the chamber wall 320. Similarly, an impedance circuit 312 may or may not be coupled to the first zone 330 of the showerhead 308. An impedance circuit 312 may or may not be coupled to the second zone 332 of the showerhead 308. If the impedance circuit 312 is present, the capacitor 316 may or may not be present and the inductor 314 may or may not be present. The first and second zones 330, 332 of the showerhead 308 may be coupled directly to ground, coupled to an impedance circuit 312, or left open at a floating potential. The susceptor 306 may be coupled directly to ground or left open at a floating potential. Additionally, the wall 320 may be left open at a floating potential.

The apparatus 300 may comprise a movable cathode (not shown) and may comprise a processing region without discontinuities. Without discontinuities may include a slit valve opening disposed at a location below the processing area. Additionally, multiple RF sources may be coupled to the apparatus 300. Various combinations of series and parallel circuit elements and/or transmission lines may be used to achieve the desired impedance. FIGS. 11A-11E show several impedance circuits that may be utilized. It is to be understood that other impedance circuits may be utilized as well.

Examples shown below will discuss various arrangements of impedance circuits coupled with a plasma processing chamber and the how the impedance circuits affect the plasma uniformity. In general, the operating range for the pressure may be between a few mTorr to several thousand mTorr.

### COMPARISON EXAMPLE 1

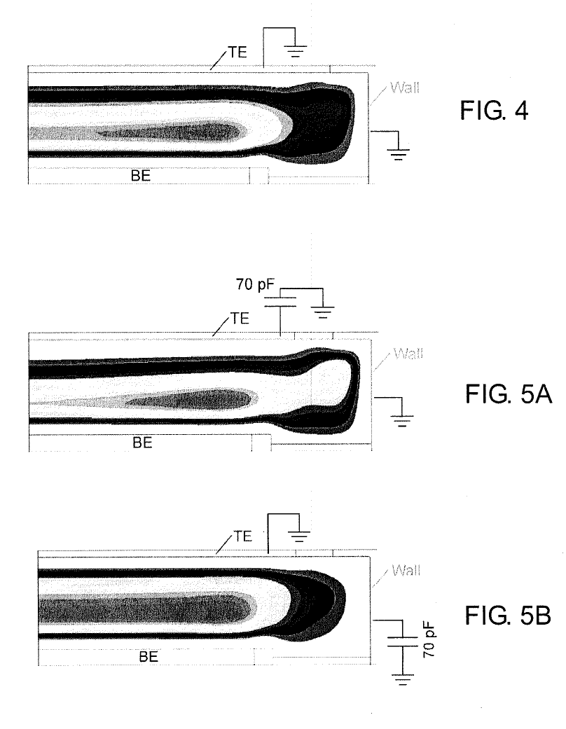

FIG. 4 shows the plasma distribution for a processing chamber in which the substrate is biased with RF current. The showerhead is coupled directly to ground, and the chamber wall is coupled directly to ground. The showerhead is spaced a few centimeters from the substrate. The plasma is an argon plasma at a pressure of about 100 mTorr. As shown in FIG. 4, the plasma density is high near the edge of the substrate.

### EXAMPLE 1

FIG. 5A shows the plasma distribution for a processing chamber in which the substrate is biased with RF current. The showerhead is coupled to ground through a capacitor having a capacitance of 70 pF. The chamber wall is directly coupled to ground. The showerhead is spaced a few centimeters from the substrate. The plasma is an argon plasma at a pressure of about 100 mTorr. As shown in FIG. 5A, the plasma density near the edge of the substrate is increased compared to the plasma density shown in FIG. 4. The capacitor functions to push the plasma towards the chamber wall.

### EXAMPLE 2

FIG. 5B shows the plasma distribution for a processing chamber in which the substrate is biased with RF current. The chamber wall is coupled to ground through a capacitor having a capacitance of 70 pF. The showerhead is directly coupled to ground. The showerhead is spaced a few centimeters from the substrate. The plasma is an argon plasma at a pressure of about 100 mTorr. As shown in FIG. 5B, the plasma density near the edge of the substrate is decreased compared to the plasma density shown in FIG. 4. The capacitor functions to push the plasma towards the showerhead.

### EXAMPLE 3

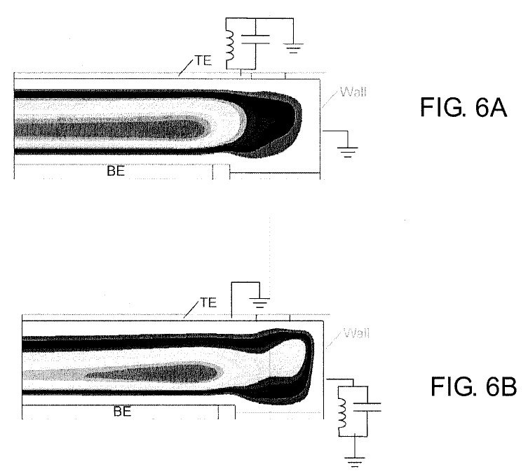

FIG. 6A shows the plasma distribution for a processing chamber in which the substrate is biased with RF current. The showerhead is coupled to ground through an inductor having an inductance of 10 nH and a capacitor having a capacitance of 0.36 nF. The chamber wall is directly coupled to ground. The showerhead is spaced a few centimeters from the substrate. The plasma is an argon plasma at a pressure of about 100 mTorr. As shown in FIG. 6A, the plasma density near the edge of the substrate is decreased compared to the plasma density shown in FIG. 4. The capacitor and inductor together function to pull the plasma towards the showerhead.

### EXAMPLE 4

FIG. 6B shows the plasma distribution for a processing chamber in which the substrate is biased with RF current. The chamber wall is coupled to ground through an inductor having an inductance of 10 nH and a capacitor having a capacitance of 0.36 nF. The showerhead is directly coupled to ground. The showerhead is spaced a few centimeters from the substrate. The plasma is an argon plasma at a pressure of about 100 mTorr. As shown in FIG. 6B, the plasma density near the edge of the substrate is increased compared to the plasma density shown in FIG. 4. The capacitor and inductor together function to pull the plasma towards the chamber wall.

### COMPARISON EXAMPLE 2

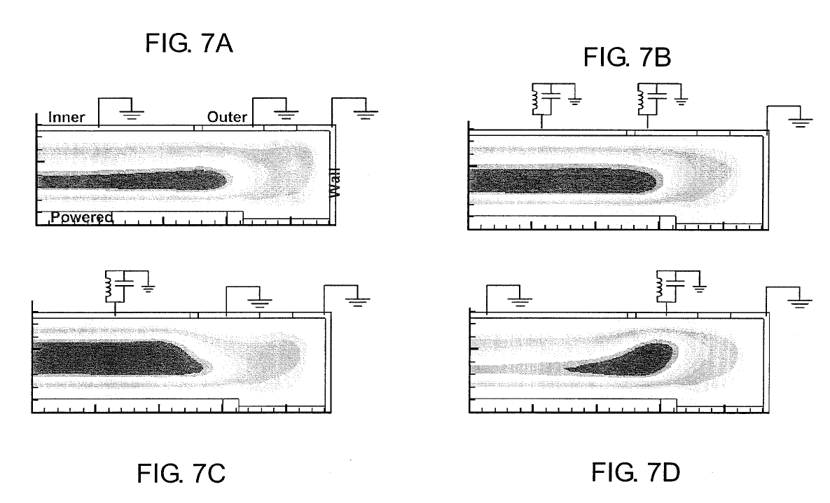

FIG. 7A shows the plasma distribution for a processing chamber in which the substrate is biased with RF current. The showerhead has both an inner zone and an outer zone circumscribing the inner zone. Both the inner zone and the outer zone are coupled directly to ground. The chamber wall is also directly coupled to ground. The showerhead is spaced a few centimeters from the substrate. The plasma is an argon plasma at a pressure of about 100 mTorr. As shown in FIG. 7A, the plasma density near the edge of the substrate is substantially the same as the plasma density shown in FIG. 4.

### EXAMPLE 5

FIG. 7B shows the plasma distribution for a processing chamber in which the substrate is biased with RF current. The showerhead has both an inner zone and an outer zone circumscribing the inner zone. Both the inner zone and the outer zone are coupled to an impedance circuit having an inductor and a capacitor. The inductor has an inductance of 30 nH and the capacitor has a capacitance of 0.1 nF. The chamber wall is directly coupled to ground. The showerhead is spaced a few centimeters from the substrate. The plasma is an argon plasma at a pressure of about 100 mTorr. As shown in FIG. 7B, the plasma density is pulled closer towards the center of the substrate and away from the wall as compared to FIG. 7A.

### EXAMPLE 6

FIG. 7C shows the plasma distribution for a processing chamber in which the substrate is biased with RF current. The showerhead has both an inner zone and an outer zone circumscribing the inner zone. The outer zone is directly coupled to ground while the inner zone is coupled to an impedance circuit. The impedance circuit comprises both an inductor and a capacitor. The inductor has an inductance of 30 nH and the capacitor has a capacitance of 0.1 nF. The chamber wall is also directly coupled to ground. The showerhead is spaced a few centimeters from the substrate. The plasma is an argon plasma at a pressure of about 100 mTorr. As shown in FIG. 7C, the plasma density is pulled closer towards the center of the substrate and away from the wall as compared to both FIG. 7A and FIG. 7B.

### EXAMPLE 7

FIG. 7D shows the plasma distribution for a processing chamber in which the substrate is biased with RF current. The showerhead has both an inner zone and an outer zone circumscribing the inner zone. The inner zone is directly coupled to ground while the outer zone is coupled to an impedance circuit. The impedance circuit comprises both an inductor and a capacitor. The inductor has an inductance of 30 nH and the capacitor has a capacitance of 0.1 nF. The chamber wall is also directly coupled to ground. The showerhead is spaced a few centimeters from the substrate. The plasma is an argon plasma at a pressure of about 100 mTorr. As shown in FIG. 7D, the plasma density is pulled closer towards the outer zone as compared to FIG. 7A, FIG. 7B, and FIG. 7C.

### EXAMPLE 8

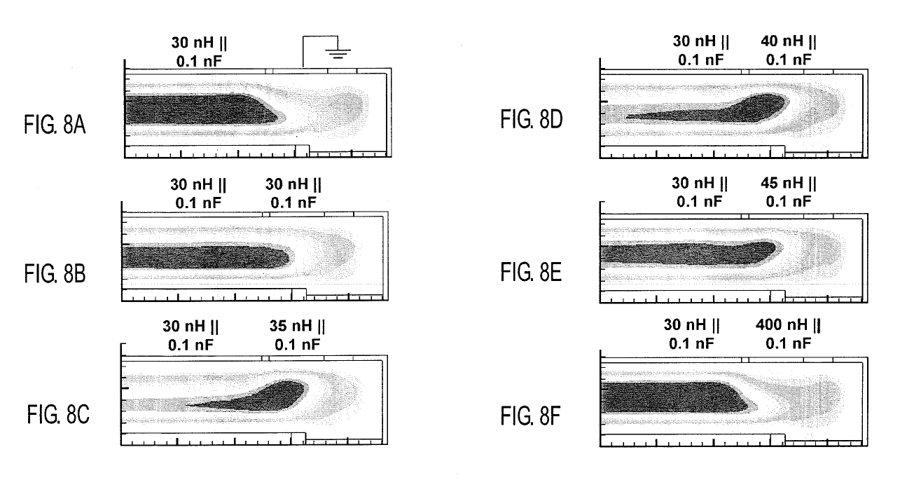

FIG. 8A shows the plasma distribution for a processing chamber in which the substrate is biased with RF current. The showerhead has both an inner zone and an outer zone circumscribing the inner zone. The outer zone is directly coupled to ground while the inner zone is coupled to an impedance circuit. The impedance circuit comprises both an inductor and a capacitor. The inductor has an inductance of 30 nH and the capacitor has a capacitance of 0.1 nF. The chamber wall is also directly coupled to ground. The showerhead is spaced a few centimeters from the substrate. The plasma is an argon plasma at a pressure of about 100 mTorr. As shown in FIG. 8A, the plasma density is pulled closer towards the center of the substrate and away from the wall.

### EXAMPLE 9

FIG. 8B shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 30 nH and the capacitor has a capacitance of 0.1 nF. For the outer zone, the inductor has an inductance of 30 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is evenly distributed between the inner and outer zones as compared to FIG. 8A.

### EXAMPLE 10

FIG. 8C shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 30 nH and the capacitor has a capacitance of 0.1 nF. For the outer zone, the inductor has an inductance of 35 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pulled closer towards the outer zone.

### EXAMPLE 11

FIG. 8D shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 30 nH and the capacitor has a capacitance of 0.1 nF. For the outer zone, the inductor has an inductance of 40 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pulled closer towards the outer zone as compared to FIG. 8A.

### EXAMPLE 12

FIG. 8E shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 30 nH and the capacitor has a capacitance of 0.1 nF. For the outer zone, the inductor has an inductance of 45 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is more evenly distributed as compared to FIG. 8D.

### EXAMPLE 13

FIG. 8F shows the plasma distribution for a processing chamber in which the substrate is biased with 1 kW RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 30 nH and the capacitor has a capacitance of 0.1 nF. For the outer zone, the inductor has an inductance of 400 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pulled closer towards the inner zone.

### EXAMPLE 14

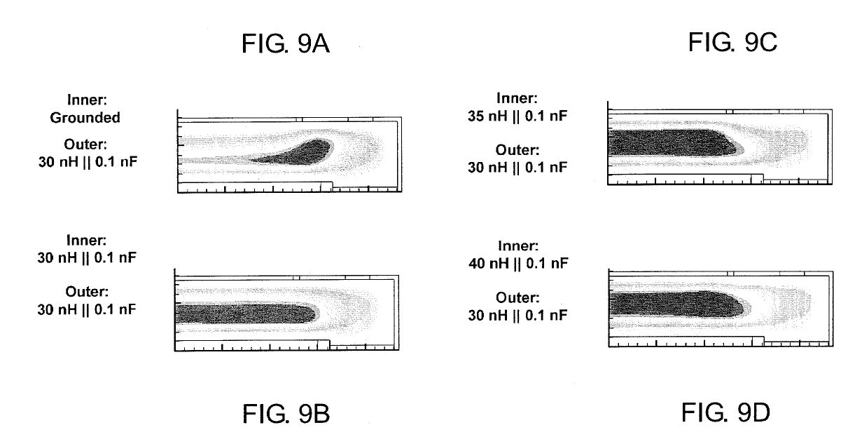

FIG. 9A shows the plasma distribution for a processing chamber in which the substrate is biased with RF current. The showerhead has both an inner zone and an outer zone circumscribing the inner zone. The inner zone is coupled directly to ground while the outer zone is coupled to an impedance circuit. The impedance circuit comprises both an inductor and a capacitor. The inductor has an inductance of 30 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pulled closer towards the outer zone.

### EXAMPLE 15

FIG. 9B shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 30 nH and the capacitor has a capacitance of 0.1 nF. For the outer zone, the inductor has an inductance of 30 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density substantially evenly distributed between the inner and outer zones.

### EXAMPLE 16

FIG. 9C shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 35 nH and the capacitor has a capacitance of 0.1 nF. For the outer zone, the inductor has an inductance of 30 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pulled closer towards the inner zone.

### EXAMPLE 17

FIG. 9D shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises both an inductor and a capacitor. For the inner zone, the inductor has an inductance of 40 nH and the capacitor has a capacitance of 0.1 nF. For the outer zone, the inductor has an inductance of 30 nH and the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pulled closer towards the inner zone.

### EXAMPLE 18

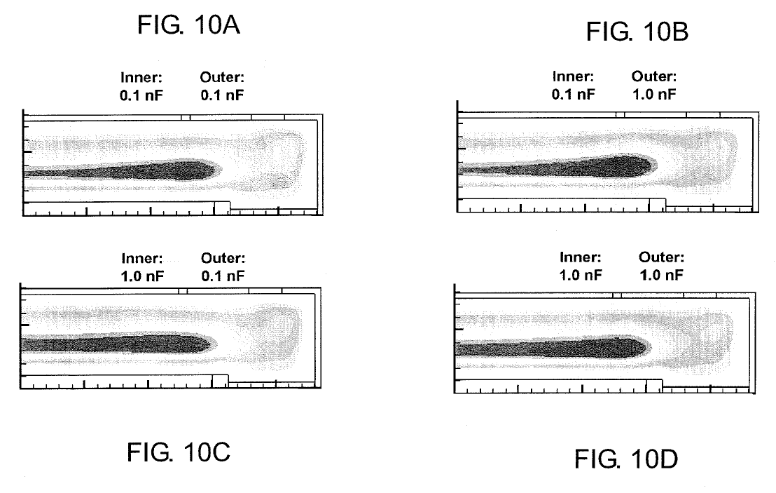

FIG. 10A shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises only a capacitor. For the inner zone, the capacitor has a capacitance of 0.1 nF. For the outer zone, the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pushed closer towards the outer zone.

### EXAMPLE 19

FIG. 10B shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises only a capacitor. For the inner zone, the capacitor has a capacitance of 0.1 nF. For the outer zone, the capacitor has a capacitance of 1.0 nF. The chamber wall is directly coupled to ground. The showerhead is spaced a few centimeters from the substrate. The plasma is an argon plasma at a pressure of about 100 mTorr. The plasma density is pushed closer towards the outer zone.

### EXAMPLE 20

FIG. 10C shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises only a capacitor. For the inner zone, the capacitor has a capacitance of 1.0 nF. For the outer zone, the capacitor has a capacitance of 0.1 nF. The chamber wall is directly coupled to ground. The showerhead is spaced a few centimeters from the substrate. The plasma is an argon plasma at a pressure of about 100 mTorr. The plasma density is pushed closer towards the inner zone.

### EXAMPLE 21

FIG. 10D shows the plasma distribution for a processing chamber in which the substrate is biased with RF current. The showerhead has both an inner zone and an outer zone circumscribing the inner zone. Both the outer zone and the inner zone are coupled to an impedance circuit. The impedance circuit comprises only a capacitor. For the inner zone, the capacitor has a capacitance of 1.0 nF. For the outer zone, the capacitor has a capacitance of 1.0 nF. The chamber wall is directly coupled to ground. The showerhead is spaced a few centimeters from the substrate. The plasma is an argon plasma at a pressure of about 100 mTorr. The plasma density is pushed closer towards the inner zone.

The impedance circuit may be preselected to control the plasma uniformity. For example, if an inductor is present, the inductance may be preselected prior to processing. During processing, the inductance may be changed to suit the needs of the process. The inductance change may occur at any time during processing. Similarly, the capacitance of the capacitor, if present, may be preselected to control the plasma uniformity. For example, the capacitance may be preselected prior to process. During processing, the capacitance may be changed to suit the needs of the process. The capacitance change may occur at any time during processing.

By selectively utilizing impedance circuits coupled to the chamber wall and/or the showerhead and/or a cathode can (if present), the plasma uniformity may be controlled to suit the needs of the user. Additionally, splitting the showerhead into at least two separate zones may provide an additional level of control over the plasma uniformity. By controlling the plasma uniformity, an etching process may be performed while reducing undesired over or under etching.

While the foregoing is directed to embodiments of the present invention, other and further embodiments of the invention may be devised without departing from the basic scope thereof, and the scope thereof is determined by the claims that follow.

1. A plasma processing apparatus, comprising:
a chamber body;
a substrate support disposed within the chamber body;
a showerhead disposed within the chamber body opposite to the substrate support;
a power supply coupled with the substrate support; and
at least one item selected from the group consisting of a capacitor, an inductor, and combinations thereof, the at least one item coupled to at least two of the chamber body, the showerhead, and the substrate support.

2. The apparatus of claim 1, wherein the at least one item is coupled to the showerhead and the chamber body.

3. The apparatus of claim 2, wherein the showerhead comprises a first region and a second region electrically isolated from the first region, wherein the at least one item is coupled to the first region.

4. The apparatus of claim 3, wherein the second region is coupled to at least one item selected from the group consisting of a capacitor, an inductor, and combinations thereof.

5. The apparatus of claim 1, wherein the at least one item is coupled to the chamber body and the substrate support.

6. The apparatus of claim 5, wherein the at least one item comprises a capacitor and an inductor coupled to the showerhead.

7. The apparatus of claim 1, wherein at least one of the chamber body and the showerhead is at a floating potential.

8. A plasma processing apparatus, comprising:
a chamber body;
a substrate support disposed within the chamber body;
a showerhead disposed within the chamber body opposite to the substrate support;
a power supply coupled with the showerhead;
a cathode can disposed within the chamber body, the cathode can substantially encircling the substrate support; and
at least one item selected from the group consisting of a capacitor, an inductor, and combinations thereof, the at least one item coupled to at least two of the chamber body, the cathode can, the showerhead, and the substrate support.

9. The apparatus of claim 8, wherein the at least one item is coupled to the chamber body and the cathode can.

10. The apparatus of claim 9, wherein the at least one item comprise a capacitor and an inductor.

11. The apparatus of claim 8, wherein the at least one item is coupled to the cathode can and the showerhead.

12. The apparatus of claim 11, wherein the at least one item comprises a capacitor and an inductor.

13. An etching apparatus, comprising:
a chamber body;
a substrate support disposed within the chamber body;
a showerhead disposed within the chamber body opposite to the substrate support;
a power supply coupled with the substrate support;
a first capacitor coupled with the showerhead;
a first inductor coupled to the showerhead;
a second capacitor coupled to the chamber body; and
a second inductor coupled to the chamber body.

14. The apparatus of claim 13, wherein the showerhead comprises a first region and a second region electrically isolated from the first region, wherein the first capacitor and the first inductor are coupled with the first region, and wherein a third capacitor and a third inductor are coupled to the second region.

15. The apparatus of claim 13, wherein the inductance of the first inductor is greater than the inductance of the second inductor.

16. The apparatus of claim 13, wherein the capacitance of the first capacitor is greater than the capacitance of the second capacitor.

17. A plasma distribution controlling method, comprising:
applying a current to a substrate disposed within a processing chamber on a substrate support, the processing chamber having a chamber body and a showerhead disposed within the chamber body opposite to the substrate; and
coupling at least two of the showerhead, the chamber body, and the substrate support to an item selected from the group consisting of an inductor, a capacitor, and combinations thereof to adjust the plasma distribution.

18. The method of claim 17, further comprising coupling one of the showerhead and the chamber body directly to ground.

19. The method of claim 17, wherein the plasma distribution controlling occurs during an etching process.

20. The method of claim 19, wherein the coupling occurs while etching a layer.
